(19) United States
(12) Patent Application Publication
(10) Pub. No.: US 2015/0075446 A1
(43) Pub. Date: Mar. 19, 2015

(54) PET TRAINING SYSTEM

(71) Applicant: Jun Hu, Shenzhen (CN)

(72) Inventor: Jun Hu, Shenzhen (CN)

(21) Appl. No.: 14/027,101

(22) Filed: Sep. 13, 2013

(51) Int. Cl. A01K 15/02

(52) U.S. Cl. CPC A01K 15/022; A01K 15/021; A01K 15/023
USPC 119/718; 119/720; 119/721

(57) ABSTRACT

A training system for a pet of a user with a smart phone includes at least one collar module that is adapted to be fixed with and deliver a stimulus to the pet. Each collar module includes an enclosure, at least one stimulus transducer, and a circuit that includes at least a power source, a wireless receiver capable of receiving an instruction signal from the portable electronic device, and a memory. The at least one stimulus transducer may be an audio transducer, a vibration transducer, an electrostatic shock transducer, or the like. A software application resident on the portable electronic device is adapted to display on the display screen a choice of actuators for the user representing one of the at least one stimulus transducers, and a pet's name in the case of multiple pets. A barking control and virtual fence arrangement is further included.

### CROSS-REFERENCE TO RELATED APPLICATIONS

Not Applicable.

### STATEMENT REGARDING FEDERALLY SPONSORED RESEARCH AND DEVELOPMENT

Not Applicable.

### FIELD OF THE INVENTION

This invention relates to animal husbandry, and more particularly to a pet training system.

### DISCUSSION OF RELATED ART

Pet training systems, and particular pet training systems for dogs, typically have a collar module that imparts a stimulus to the dog, such as an electrostatic shock or audible buzzer or tone, in response to a behavior that a user desires to correct. For example, if the dos is barking, the user can use a remote transmitter to actuate the stimulus to let the dog know that such behavior is not desired. Such remote transmitters may further include a level setting to allow the strength of the stimulus to be adjusted. Further, such systems may have multiple types of stimuli, such as audio and tactile stimuli.

However, such prior art dog training systems do not provide for the convenience of controlling the system through a user's smart phone or other portable electronic device. Further, prior art systems do not allow for multiple pets to be easily added or removed from the remote controller. Prior art systems do not provide a means for varying the strength of each stimulus based on a particular pet.

Prior art so-called virtual fences are also known, whereby a receiver on the pet's collar detects proximity to a fence border defined by a wire having a signal imparted thereon that is detectable by the receiver. When the signal strength reaches a predetermined threshold, the receiver activates the stimulus to alert the pet that an area he is approaching is off-limits. Such prior art systems do not allow different fence lines for different pets, or different stimuli at different distances for each pet.

Prior art barking control systems include a collar module fitted with a vibration sensor or microphone to detect the barking of the pet, whereupon they deliver a stimulus to the pet to let the pet know that barking is not permitted. Such prior art bark control systems do not provide different stimuli for different pets, nor do they provide differing “grace periods” for allowing barking to only occur for a programmed period of time. Therefore, there is a need for a device that overcomes the above-mentioned drawbacks. The present invention accomplishes these objectives.

### SUMMARY OF THE INVENTION

The present device a training system for a pet of a user. The pet is preferably wearing a collar or other article, and the user has a portable electronic device, such as a smart mobile phone, or the like, that has at least a wireless transmitter, a receiver and a display screen.

The system includes at least one collar module that is adapted to be fixed with the collar and to deliver a stimulus to the pet. Each collar module includes an enclosure that has at least one collar attachment mechanism, at least one stimulus transducer, and a circuit that includes at least a power source, a wireless receiver capable of receiving an instruction signal from the portable electronic device, and a memory. The at least one stimulus transducer may be an audio transducer, a vibration transducer, an electrostatic shock transducer, or the like.

The collar module is adapted to assign a distance from the portable electronic device based on a strength measurement of the instruction signal from the portable electronic device. In response to the instruction signal received from the portable electronic device, at least one distance threshold may be programmed in the memory of the circuit and associated with one of the at least one stimulus transducers. As such, if the distance from the portable electronic device exceeds one of the distance thresholds the associated stimulus transducer is activated. Further, the software application is adapted to display a level setting of each stimulus transducer on the display screen, and to display a control for allowing the user to change the level setting of each stimulus transducer.

A software application resident on the portable electronic device is adapted to display on the display screen a choice of actuators for the user. Each actuator represents one of the at least one stimulus transducers. The software application enables the portable electronic device to further send the instruction signal to the circuit of the collar modules for activating the at least one stimulus transducer of the collar module selected by the user on the display screen.

In one embodiment, the software application is adapted to display a bark training setting and an on/off indicator for each of the at least one stimulus transducer on the display screen. A control is further displayed and allows for the user to change the bark training setting and the on/off indicator for each of the at least one stimulus transducer. Further, the circuit of the collar module additionally includes a bark sensor, such that when the bark sensor detects that the pet is barking, the selected stimulus transducers are activated based on the bark training settings and the on/off indicator for each of the stimulus transducers.

In one embodiment, the circuit further includes a wireless transmitter capable of sending information signals to the portable electronic device. The software application is further adapted to receive the information signals of the collar module with its receiver. The wireless transmitter is adapted to send the distance measurement to the portable electronic device and the software application is adapted to display the distance measurement on the display screen, such that the user is informed of the distance between him and the pet.

In one embodiment, wherein the user has a plurality of pets wearing a collar, a plurality of the collar modules are included, each having the enclosure that is adapted to receive a visually-distinct sleeve therearound. The memory of each collar module includes a collar module address distinct from the collar module addresses of each other collar module.

In such an embodiment the software application is adapted to display on the display screen a choice of actuators associated with the selected pet, each pet associated with the unique collar module address of the collar module worn by that pet. The software application may further allow each distinct pet to be named by the user so that actuators may be displayed for each pet by name. Alternately, each distinct pet may be assigned a color matching the visually-distinct sleeve around the collar module worn by the pet. In this way, the user is able to differentiate each pet when sending commands to the collar module of each pet.

In such an embodiment having multiple collar modules and pets, and wherein the portable electronic device is connected with a large area wireless network, each collar module may receive the instruction signals through the large area wireless network. In this way the range of the system may be expanded. Further, in the embodiment wherein each collar module includes one of the wireless transmitters, each collar module may be adapted to transmit its location through the network to the portable electronic device, its location determined by triangulation location data delivered by the network where available, or by further inclusion of a GPS module in the circuit that determines the latitude and longitude coordinates of the collar module.

In such an embodiment, the portable electronic device may include a map on the display with position indicators for each of the collar modules. The software application may further provide a fence control for allowing the user to draw a virtual fence on the map and around the positions of each of the collar modules, such that if any of the pets wander outside of the boundaries of the fence the portable electronic device transmits an instruction signal to that pet's collar module to activate one or more of the stimulus transducers. Further, the distance thresholds may be established in such an embodiment such that the distance may be calculated by the location of each pet and the virtual fence.

In the embodiment including the large area wireless network, the portable electronic device is not required to be portable, and instead may be a desktop computer at a fixed location, such as a residence for example. In such an embodiment, the virtual fence may be established as the boundary of the residential property, or the immediate neighborhood of the pet, for example, subject to the accuracy and resolution of the GPS module or the triangulation calculation delivered by the wide area wireless network.

The present invention provides for the convenience of controlling the pet training system through a user's smart phone or other portable electronic device. Further, multiple pets may be easily added or removed from the remote controller. The strength of each stimulus based on a particular pet may also be readily controlled by the present invention, which also provides for a virtual fence with variable fence lines for different pets, and different stimuli at different distances away from the fence for each pet. The present invention further provides a bark control system having different stimuli for different pets, as well as differing “grace periods” for allowing barking to only occur for a programmed period of time, a different grace period for each pet. Other features and advantages of the present invention will become apparent from the following more detailed description, taken in conjunction with the accompanying drawings, which illustrate, by way of example, the principles of the invention.

### DESCRIPTION OF THE DRAWINGS

FIG. 1 is a perspective view of a user with a portable electronic device in wireless communication with a collar module of a pet;

FIG. 2 is a rear perspective view of a collar module with a visually distinct sleeve;

FIG. 3 is a rear perspective view of FIG. 2 with the sleeve omitted;

FIG. 4 is a block diagram representing the components of the collar module;

FIG. 5 is a display screen of the portable electronic device, showing a plurality of stimulus transducer controls;

FIG. 6 is the display screen of the portable electronic device, showing a level setting;

FIG. 7 is the display screen of the portable electronic device, showing a plurality of pets and a selector control therefore;

FIG. 8 is the display screen of the portable electronic device, showing a map with relative distances between each of a plurality of pets and the user;

FIG. 9 is the display screen of the portable electronic device, showing a bark training control; and

FIG. 10 is the display screen of the portable electronic device, showing a virtual fence on a map with the locations of two of the pets displayed.

### DETAILED DESCRIPTION OF THE PREFERRED EMBODIMENT

Illustrative embodiments of the invention are described below. The following explanation provides specific details for a thorough understanding of and enabling description for these embodiments. One skilled in the art will understand that the invention may be practiced without such details. In other instances, well-known structures and functions have not been shown or described in detail to avoid unnecessarily obscuring the description of the embodiments.

Unless the context clearly requires otherwise, throughout the description and the claims, the words “comprise,” “comprising,” and the like are to be construed in an inclusive sense as opposed to an exclusive or exhaustive sense; that is to say, in the sense of “including, but not limited to.” Words using the singular or plural number also include the plural or singular number respectively. Additionally, the words “herein,” “above,” “below” and words of similar import, when used in this application, shall refer to this application as a whole and not to any particular portions of this application. When the claims use the word “or” in reference to a list of two or more items, that word covers all of the following interpretations of the word: any of the items in the list, all of the items in the list and any combination of the items in the list. When the word “each” is used to refer to an element that was previously introduced as being at least one in number, the word “each” does not necessarily imply a plurality of the elements, but can also mean a singular element.

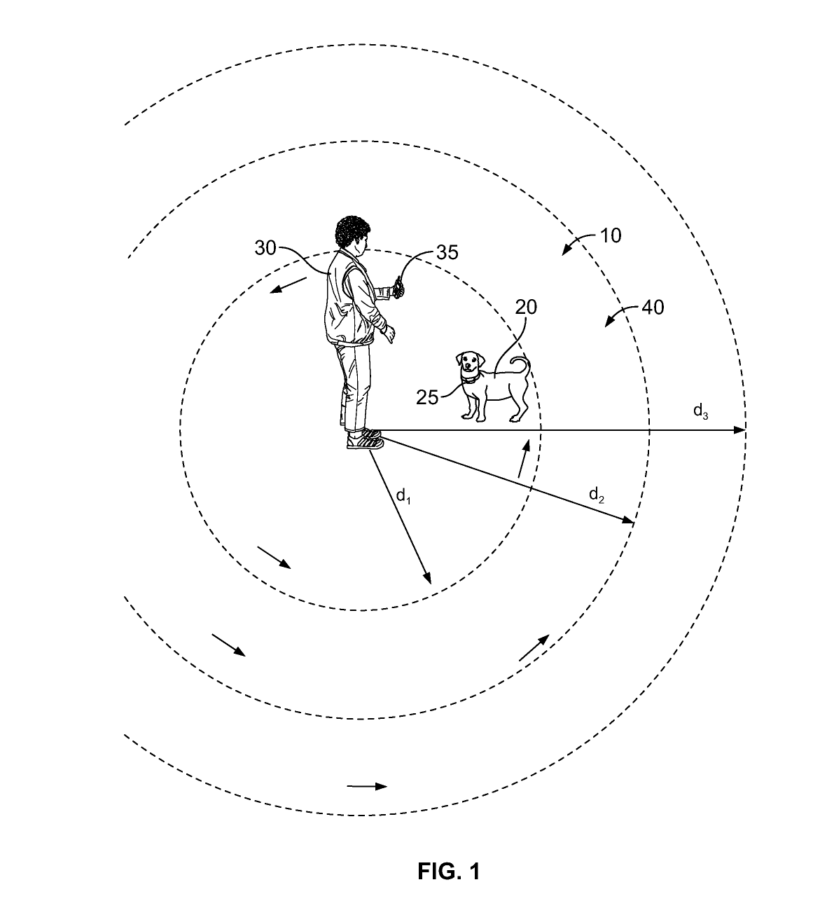

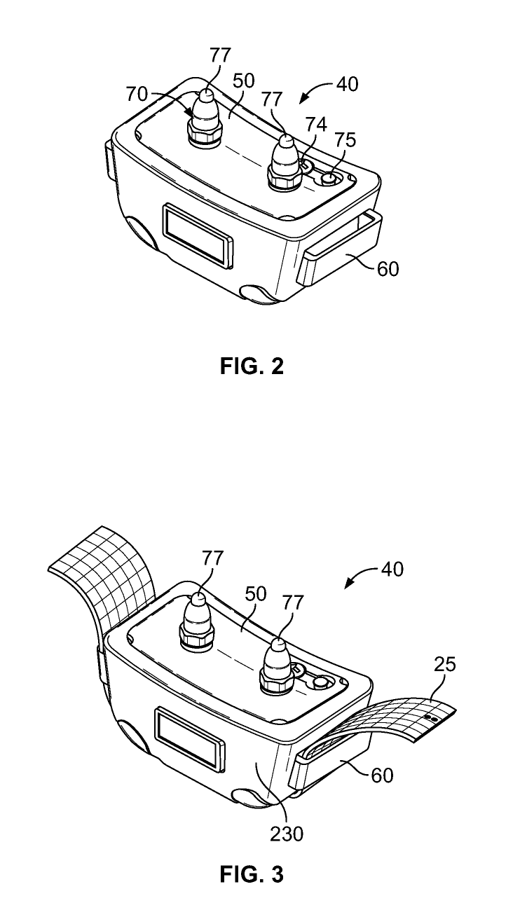

FIGS. 1 and 2 illustrate a training system 10 for a pet 20 of a user 30. The pet 20 is preferably wearing a collar 25 or other article, and the user 30 has a portable electronic device 35, such as a smart mobile phone, or the like, that has at least a wireless transmitter 36, a receiver 37 and a display screen 38.

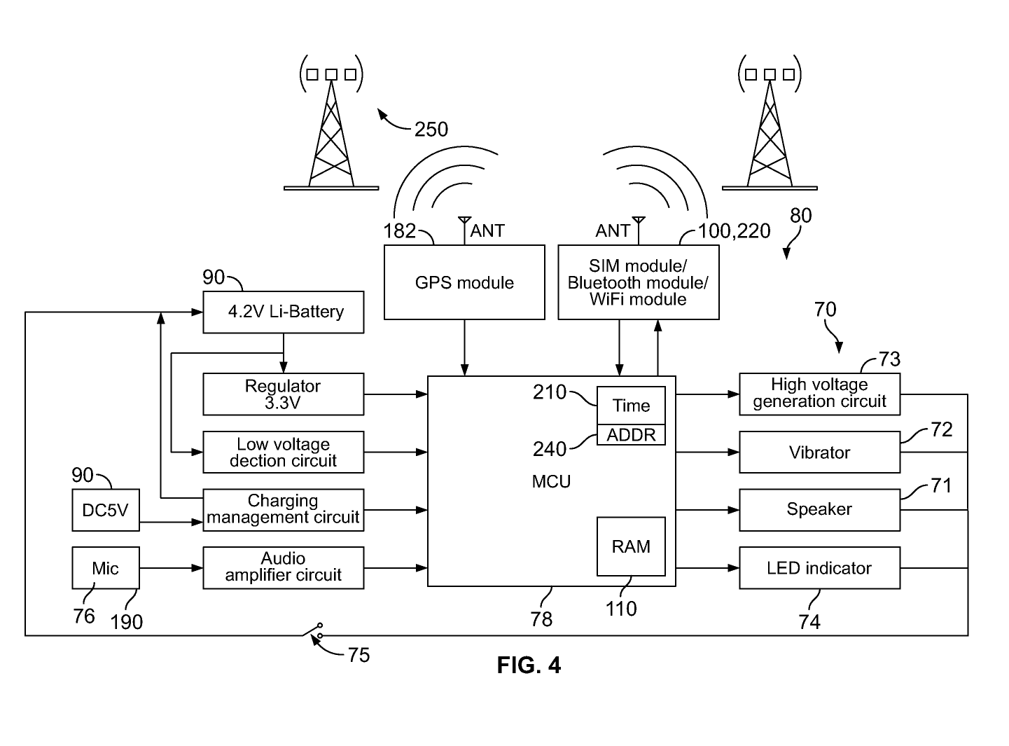

The system 10 includes at least one collar module 40 that is adapted to be fixed with the collar 25 and to deliver a stimulus to the pet 20. Each collar module 40 includes an enclosure 50 that has at least one collar attachment mechanism 60, at least one stimulus transducer 7 (FIG. 4), and a circuit 80 that includes at least a power source 90, such as a rechargeable or replaceable battery, a wireless receiver 100 capable of receiving an instruction signal from the portable electronic device 35, and a memory 110.

The at least one stimulus transducer 70 may be an audio transducer 71, such as a buzzer, speaker, or piezoelectric buzzer, as is known in the art. Another of the at least one stimulus transducers 70 may be a vibration transducer 72, such as an electric motor having an offset weight, as is known in the art. Another of the at least one stimulus transducers 70 may be an electrostatic shock transducer 73 having at least two electrodes 77 adapted to contact the pet 20 when the collar module 40 is fixed with the collar 25 to the pet 20, as is known in the art. Other types of transducers 70 may be included as they are discovered or determined appropriate for affecting pet behavior.

An LED indicator 74 may be further included for indicating that the circuit 80 is in an active or “on” state, as opposed to a hibernation or “off” state. A power button 75 may be further included for activating the circuit 80 or deactivating the circuit 80. Further a microphone 76 may be included in the circuit 80 along with a processor 78 for storing a vocal command of the user 30 into the memory 110 for playback through the audio transducer 71 when the audio transducer 71 is activated. For example, the voice command maybe “Stop” or “Down” or “Quiet,” or other commands typically given by a pet owner. Multiple such vocal commands may be stored for use in different circumstances or states of the system 10.

The collar module 40 is adapted to assign a distance d from the portable electronic device 35 based on a strength measurement of the instruction signal from the portable electronic device 35. In response to the instruction signal received from the portable electronic device 35, at least one distance threshold d_{T} may be programmed in the memory 110 of the circuit 80 and associated with one of the at least one stimulus transducers 70. As such, if the distance d from the portable electronic device 35 exceeds one of the distance thresholds d_{T} the associated stimulus transducer 70 is activated.

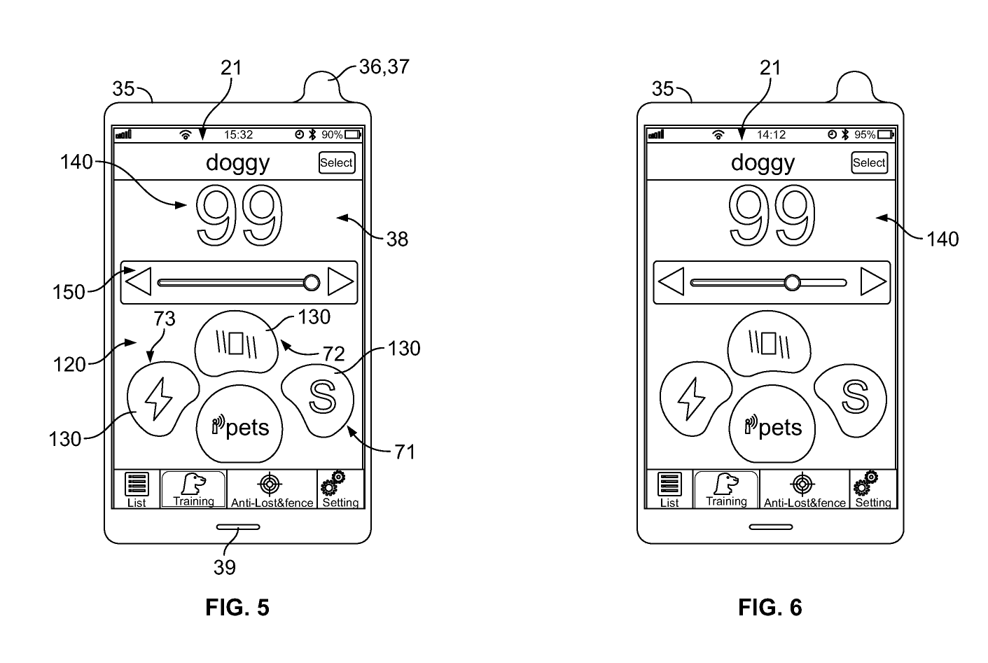

For example, the user 30 may determine that the pet 20 should get an audible warning from the audio transducer 71 if the pet 20 exceeds a first distance threshold d₁ of 20 meters away from the user 30, a vibration warning from the vibration transducer 72 if the pet exceeds a second distance threshold d₂ of 30 meters away from the user 30, and an electrostatic shock front the electrostatic shock transducer 73 if the pet 20 exceeds a third distance threshold d₃ of 40 meters away from the user 30. In this way, once the pet 20 experiences all of the different types of stimulus that the system 10 provides and correlates them to the distances away from the user 30 where they are each activated, the pet 20 will tend to stay within the first distance threshold d₁ of 20 meters. Each of these distance thresholds d_{T} may be changed by the user 30 by adjusting an associated actuators 130 (FIG. 5) in the software application 120.

Further, the software application 120 is adapted to display a level setting 140 (FIGS. 5 and 6) of each stimulus transducer 70 on the display screen 38, and to display a control 150 for allowing the user to change the level setting 140 of each stimulus transducer 70. The software application 120, through the portable electronic device 35, transmits an instruction signal representative of the selected level setting 140 set for each stimulus transducer 70 to the circuit 80, and the circuit 80 is adapted to store each level setting 140 in the memory 110. As such, when each stimulus transducer 70 is activated, the stimulus transducer 70 is attenuated based on the associated level setting 140. For example, if the level setting for the electric shock transducer 73 is set at 50%, then when the electric shock transducer 73 is activated it is only activated at 50% of its full potential strength.

A software application 120 resident on the portable electronic device 35 is adapted to display on the display screen 38 a choice of actuators 130 for the user 30. Each actuator 130 represents one of the at least one stimulus transducers 70. The software application 120 enables the portable electronic device 35 to further send the instruction signal to the circuit 80 of the collar modules 40 for activating the at least one stimulus transducer 70 of the collar module 40 selected by the user on the display screen 38.

In one embodiment, the software application 120 is adapted to display a bark training setting 160 and an on/off indicator 170 for each of the at least one stimulus transducer 70 on the display screen 38. A control 180 is further displayed and allows for the user 30 to change the bark training setting 160 and the on/off indicator 170 for each of the at least one stimulus transducer 70. The software application 120, in such an embodiment, is adapted to transmit an instruction signal representative of the selected bark training setting 160 and the on/off indicator 170 for each of the at least one stimulus transducer 70 to the circuit 80. The circuit 80 is adapted to store the bark training setting 160 and the associated on/off indicator 170 for each of the at least one stimulus transducers 70 in the memory 110. Further, the circuit 80 of the collar module 40 additionally includes a bark sensor 190, such that when the bark sensor 190 detects that the pet 40 is barking, the selected stimulus transducers 70 are activated based on the bark training settings 160 and the on/off indicator for each of the stimulus transducers 70.

In one such embodiment, the bark training setting 160 includes on and off states, whereby when in the off state the circuit 80 of the collar module 40 does not activate the at least one stimulus transducer 70 even when the bark sensor 190 detects that the pet 20 is barking. The bark training stetting 160, in addition to the on/off indicators 170 representative of their on and off states, further includes a grace time indication 200. The circuit 80, in such an embodiment, further includes a timer 210, such that when a positive grace time 200 is set on the portable electronic device 35 by the user 30, the circuit 80 of the collar module 40 activates the associated at least one stimulus transducer 70 only after the bark sensor 190 detects the pet 20 has barked for a longer duration than the grace time 200.

In one embodiment, the circuit 80 further includes a wireless transmitter 220 capable of sending information signals to the portable electronic device 35. The software application 120 is further adapted to receive the information signals of the collar module 40 with its receiver 37. The wireless transmitter 220 is adapted to send the distance adapted to display the distance measurement d on the display screen 38, such that the user 30 is informed of the distance d between him and the pet 20.

In an embodiment wherein the portable electronic device 35 includes a microphone 39, the user 30 may speak to the pet 20 through the microphone 39, the software application 120 transmitting the vocal signal to the pet 20 through the wireless transmitter 36 to the wireless receiver 100 of the collar module to be played on the audio transducer 71, for example.

In one embodiment, wherein the user 30 has a plurality of pets 20 wearing a collar 25, a plurality of the collar modules 40 are included, each having the enclosure 50 that is adapted to receive a visually-distinct sleeve 230 therearound (FIG. 3), the sleeve 230 being a unique color or having a unique pattern applied thereto, for example. The memory 110 of each collar module 40 includes a collar module address 240 distinct from the collar module addresses 240 of each other collar module 40.

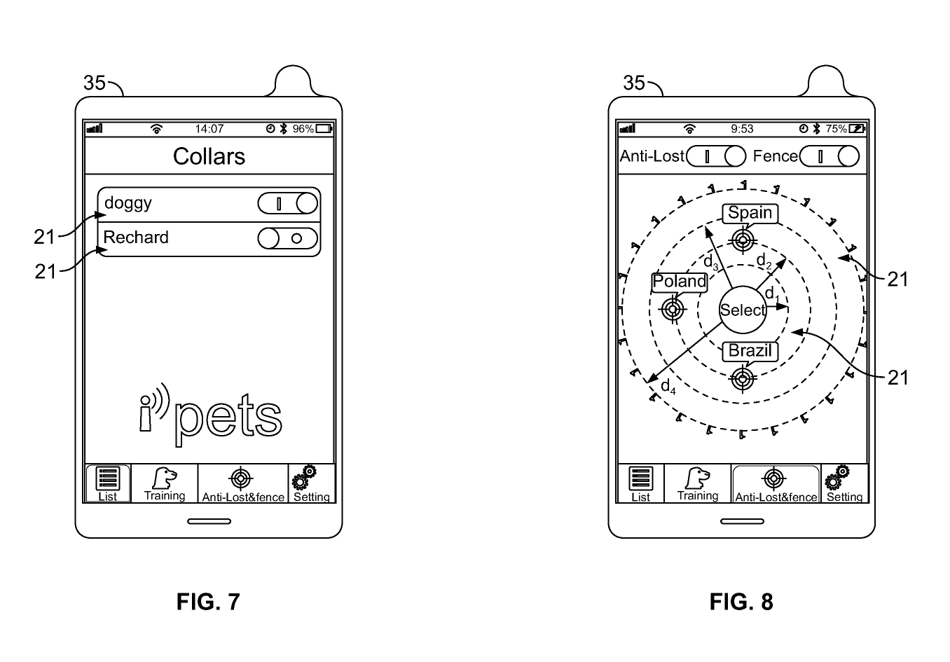

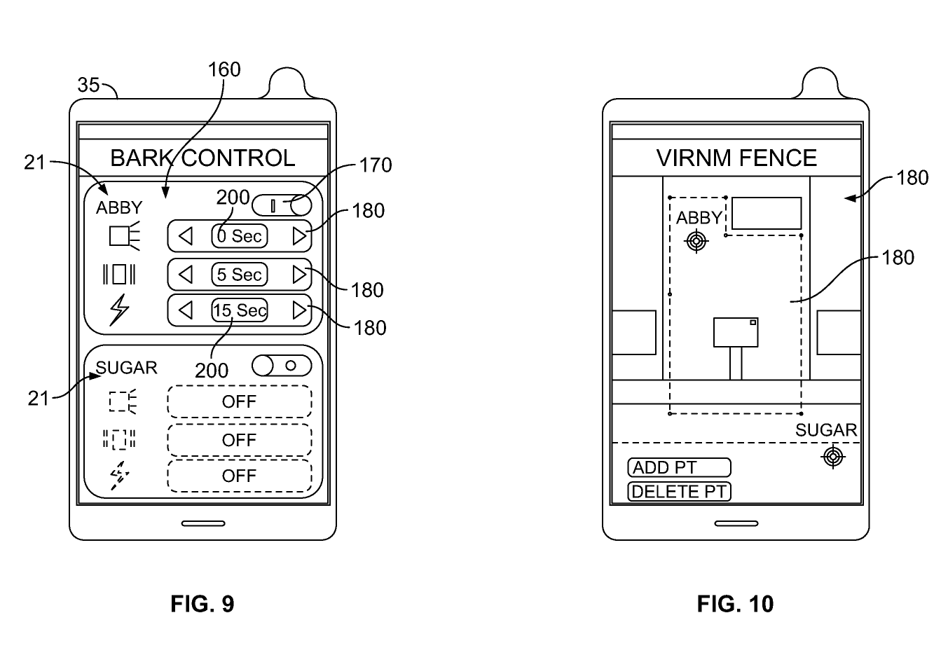

In such an embodiment the software application 120 is adapted to display on the display screen 38 a choice of actuators 130 associated with the selected pet 20, each pet 20 associated with the unique collar module address 240 of the collar module 40 worn by that pet 20. The software application 120 may further allow each distinct pet 20 to be named by the user 30 (FIG. 7) so that actuators 130 may be displayed for each pet 20 by name 21 (FIGS. 5-7 and 9). Alternately, each distinct pet 20 may be assigned a color In this way, the user 20 is able to differentiate each pet 20 when sending commands to the collar module 40 of each pet 20. It may be the case, for example, that a first of the pets 20 is able to wander a further distance d than another pet 20 without becoming lost, and as such the distance thresholds d_{T} set for the first pet 20 may be set further away than the distance thresholds d_{T} that are set for the second pet 20.

In such an embodiment having multiple collar modules 40 and pets 20, and wherein the portable electronic device 35 is connected with a large area wireless network 250 such as a WiFi network, GPRS, GSM, 3G or 4G cellular networks, paging network, SMS networks, or the like, each collar module 40 may receive the instruction signals through the large area wireless network 250. In this way the range of the system 10 may be expanded.

Further, in the embodiment wherein each collar module 40 includes one of the wireless transmitters 220, each collar module 40 may be adapted to transmit its location through the network 250 to the portable electronic device 35, its location determined by triangulation location data delivered by the network 250 where available, or by further inclusion of a GPS module 182 in the circuit 80 that determines the latitude and longitude coordinates of the collar module 40.

In such an embodiment, the portable electronic device 35 may include a map 182 on the display 35 (FIGS. 8 and 10) with position indicators for each of the collar modules 40. The software application 120 may further provide a fence control 180 for allowing the user to draw a virtual fence 181 on the map 182 and around the positions of each of the collar modules 40, such that if any of the pets 20 wander outside of the boundaries of the fence 181 the portable electronic device 35 transmits an instruction signal to that pet's collar module 40 to activate one or more of the stimulus transducers 70. Further, the distance thresholds d_{T} may be established in such an embodiment such that the distance d may be calculated by the location of each pet 20 and the virtual fence 181. For example, the user 30 may determine that any particular pet 20 gets an audible warning from the audio transducer 71 if the pet 20 comes within a first distance threshold d₁ of the virtual fence 181, such as 20 meters. Such a pet 20 may receive a vibration warning from the vibration transducer 72 if the pet approaches within a second distance threshold d₂ of the virtual fence 181 of 10 meters, for example. Such a pet may receive an electrostatic shock front the electrostatic shock transducer 73 if the pet 20 crosses the virtual fence 181, wherein the third distance threshold d₃ is zero meters or outside of the virtual fence 181. In this way, once the pet 20 experiences all of the different types of stimulus that the system 10 provides and correlates them to the distances away from the virtual fence, the pet 20 will tend to stay within the virtual fence 181. Each of these distance thresholds d_{T} may be changed by the user 30 by adjusting the associated actuators 130 in the software application 120, and each of these distance thresholds d_{T} may be set differently for each pet 20 and their associated collar module 40.

In the embodiment including the large area wireless network 250, the portable electronic device 35 is not required to be portable, and instead may be a desktop computer at a fixed location, such as a residence for example. In such an embodiment, the virtual fence 181 may be established as the boundary of the residential property, or the immediate neighborhood of the pet 20, for example, subject to the accuracy and resolution of the GPS module 182 or the triangulation calculation delivered by the wide area wireless network 250.

While a particular form of the invention has been illustrated and described, it will be apparent that various modifications can be made without departing from the spirit and scope of the invention. For example, while the system 10 is contemplated for use with the pets 20 being dogs, other pet species may be able to be trained with such a system. Accordingly, it is not intended that the invention be limited, except as by the appended claims.

Particular terminology used when describing certain features or aspects of the invention should not be taken to imply that the terminology is being redefined herein to be restricted to any specific characteristics, features, or aspects of the invention with which that terminology is associated. In general, the terms used in the following claims should not be construed to limit the invention to the specific embodiments disclosed in the specification, unless the above Detailed Description section explicitly defines such terms. Accordingly, the actual scope of the invention encompasses not only the disclosed embodiments, but also all equivalent ways of practicing or implementing the invention.

The above detailed description of the embodiments of the invention is not intended to be exhaustive or to limit the invention to the precise form disclosed above or to the particular field of usage mentioned in this disclosure. While specific embodiments of, and examples for, the invention are described above for illustrative purposes, various equivalent modifications are possible within the scope of the invention, as those skilled in the relevant art will recognize. Also, the teachings of the invention provided herein can be applied to other systems, not necessarily the system described above. The elements and acts of the various embodiments described above can be combined to provide further embodiments.

All of the above patents and applications and other references, including any that may be listed in accompanying filing papers, are incorporated herein by reference. Aspects of the invention can be modified, if necessary, to employ the systems, functions, and concepts of the various references described above to provide yet further embodiments of the invention.

Changes can be made to the invention in light of the above “Detailed Description.” While the above description details certain embodiments of the invention and describes the best mode contemplated, no matter how detailed the above appears in text, the invention can be practiced in many ways. Therefore, implementation details may vary considerably while still being encompassed by the invention disclosed herein. As noted above, particular terminology used when describing certain features or aspects of the invention should not be taken to imply that the terminology is being redefined herein to be restricted to any specific characteristics, features, or aspects of the invention with which that terminology is associated.

While certain aspects of the invention are presented below in certain claim forms, the inventor contemplates the various aspects of the invention in any number of claim forms. Accordingly, the inventor reserves the right to add additional claims after filing the application to pursue such additional claim forms for other aspects of the invention.

What is claimed is:

1. A training system for a pet of a user, the pet wearing a collar and the user having a portable electronic device that includes at least a wireless transmitter, a receiver and a display screen, the system comprising:
a collar module adapted to be fixed with a collar and to deliver a stimulus to the pet, the collar module including an enclosure having at least one collar attachment mechanism, at least one stimulus transducer, and a circuit that includes at least a power source, a wireless receiver capable of receiving an instruction signal from the portable electronic device and a memory;
a software application resident on the portable electronic device adapted to display on the display screen a choice of actuators for the user, each representing one of the at least one stimulus transducers, and sending the instructions signal through the portable electronic device to the circuit of the collar module for activating the at least one stimulus transducer of the collar module selected by the user on the display screen.

2. The training system of claim 1 wherein the circuit of the collar module is adapted to assign a distance from the portable electronic device based on a strength measurement of the instruction signal from the portable electronic device, and wherein at least one distance threshold may be programmed in the memory of the circuit and associated with from the portable electronic device, whereby if the distance from the portable electronic device exceeds one of the distance thresholds the associated stimulus transducer is activated.

3. The training system of claim 1 wherein the software application is adapted to display a level setting of each stimulus transducer on the display screen, and to display a control for allowing the user to change the level setting of each stimulus transducer, and to transmit an instruction signal representative of the selected level setting set for each stimulus transducer to the circuit, the circuit adapted to store each level setting in the memory, whereby when each stimulus transducer is activated the stimulus transducer is attenuated based on the associated level setting.

4. The training system of claim 1 wherein the software application is adapted to display a bark training setting and an on/off indicator for each of the at least one stimulus transducers on the display screen, and to display a control for allowing the user to change the bark training setting and the on/off indicator for each of the at least one stimulus transducers, and to transmit an instruction signal representative of the selected bark training setting and the on/off indicator for each of the at least one stimulus transducers to the circuit, the circuit adapted to store the bark training setting and associated on/off indicator for each of the at least one stimulus transducers in the memory, and wherein the circuit of the collar module further includes a bark sensor, whereby when the bark sensor detects that the pet is barking, the selected stimulus transducers are activated based on the bark training settings.

5. The training system of claim 4 wherein the bark training setting includes on and off states, whereby when in the off state the circuit of the collar module does not activate the at least one stimulus transducer even when the bark sensor detects the pet is barking.

6. The training system of claim 4 wherein the bark training setting includes on and off states and a grace time indication, and wherein the circuit further includes a timer, whereby when a positive grace time is set on the portable electronic device by the user, the circuit of the collar module activates the associated at least one stimulus transducers only after the bark sensor detects the pet has barked for a longer duration than the grace time.

7. The training system of claim 2 wherein the circuit further includes a wireless transmitter capable of sending information signals to the portable electronic device, and wherein the software application resident on the portable electronic device is further adapted to receive the information signals of the collar module, the wireless transmitter adapted to send the distance measurement to the portable electronic device and the software application adapted to display the distance measurement on the display screen, whereby the user is informed of the distance between him and the pet.

8. A training system for a plurality of pets of a user, each pet wearing a collar and the user having a portable electronic device that includes at least a wireless transmitter, a receiver and a display screen, the system comprising:
a plurality of collar modules each adapted to be fixed with the collar of one of the pets and to deliver a stimulus to the pet, the collar module including an enclosure having at least one collar attachment mechanism and adapted to receive a visually-distinct sleeve therearound, at least one stimulus transducer, and a circuit that includes at least a power source, a wireless receiver capable of receiving an instruction signal from the portable electronic device and a memory that includes a collar module address distinct from the collar module addresses of each other collar module;
a software application resident on the portable electronic device adapted to display on the display screen a choice of actuators for the user for each pet, each representing one of the at least one stimulus transducers, and sending the instruction signal including the collar module address associated with the selected pet through the portable electronic device to the circuit of each collar module for activating the at least one stimulus transducer of the collar module selected by the user on the display screen based on matching collar module addresses.

9. The training system of claim 8 wherein the circuit of each collar module is adapted to assign a distance from the portable electronic device based on a strength measurement of the instruction signal from the portable electronic device, and wherein at least one distance threshold may be programmed in the memory of the circuit and associated with one of the at least one stimulus transducers, in response to the instruction signal and a matching collar module address received from the portable electronic device, whereby if the distance from the portable electronic device exceeds one of the distance thresholds the associated stimulus transducer is activated.

10. The training system of claim 8 wherein the software application is adapted to display a level setting of each stimulus transducer on the display screen for each pet, and to display a control for allowing the user to change the level setting of each stimulus transducer for each pet, and to transmit an instruction signal and collar module address representative of the selected level setting set for each stimulus transducer and pet to each collar module, the circuit of each collar module adapted to store each level setting in the memory, whereby when each stimulus transducer is activated the stimulus transducer is attenuated based on the associated level setting.

11. The training system of claim 8 wherein the software application is adapted to display a bark training setting and an on/off indicator for each of the at least one stimulus transducers on the display screen for each pet, and to display a control for allowing the user to change the bark training setting and the on/off indicator for each of the at least one stimulus transducers for each pet, and to transmit an instruction signal and collar module address representative of the selected bark training setting and the on/off indicator for each of the at least one stimulus transducers to the circuit, the circuit adapted to store the bark training setting and associated on/off indicator for each of the at least one stimulus transducers in the memory, and wherein the circuit of the collar module further includes a bark sensor, whereby when the bark sensor detects that the pet is barking, the selected stimulus transducers are activated based on the bark training settings.

12. The training system of claim 11 wherein the bark training setting includes on and off states, whereby when in the off state the circuit of the collar module does not activate the at least one stimulus transducer even when the bark sensor detects the pet is barking.

13. The training system of claim 11 wherein the bark training setting includes on and off states and a grace time indication, and wherein the circuit further includes a timer, whereby when a positive grace time is set for each pet on the portable electronic device by the user, the circuit of the collar module activates the associated at least one stimulus transducers only after the bark sensor detects the designated pet is barking for a longer duration than the grace time.

14. The training system of claim 9 wherein the circuit further includes a wireless transmitter capable of sending information signals and its collar module address to the portable electronic device, and wherein the software application resident on the portable electronic device is further adapted to receive the information signals of each collar module, the wireless transmitter adapted to send the distance measurement to the portable electronic device and the software application adapted to display the distance measurement on the display screen for each pet, whereby the user is informed of the distance between him and each pet.

15. A training system for a plurality of pets of a user, each pet wearing a collar and the user having a portable electronic device that includes at least a wireless transmitter, a receiver and a display screen, the portable electronic device wireless connected with a large area wireless network, the system comprising:
a plurality of collar modules each adapted to be fixed with the collar of one of the pets and to deliver a stimulus to the pet, the collar module including an enclosure having at least one collar attachment mechanism and adapted to receive a visually-distinct sleeve therearound, at least one stimulus transducer, and a circuit that includes at least a power source, a wireless receiver capable of receiving an instruction signal from the portable electronic device through the large area wireless network and a memory that includes a collar module address distinct from the collar module addresses of each other collar module connected through the large area wireless network;
a software application resident on the portable electronic device adapted to display on the display screen a choice of actuators for the user for each pet, each representing one of the at least one stimulus transducers, and sending the instructions signal including the collar module address associated with the selected pet through the portable electronic device and the large area wireless network to the circuit of each collar module for activating the at least one stimulus transducer of the collar module selected by the user on the display screen based on matching collar module addresses.

16. The training system of claim 15 wherein the software application is adapted to display a level setting of each stimulus transducer on the display screen for each pet, and to display a control for allowing the user to change the level setting of each stimulus transducer for each pet, and to transmit an instruction signal and collar module address representative of the selected level setting set for each stimulus transducer and pet to each collar module, the circuit of each collar module adapted to store each level setting in the memory, whereby when each stimulus transducer is activated the stimulus transducer is attenuated based on the associated level setting.

17. The training system of claim 15 wherein the software application is adapted to display a bark training setting and an on/off indicator for each of the at least one stimulus transducers on the display screen for each pet, and to display a control for allowing the user to change the bark training setting and the on/off indicator for each of the at least one stimulus transducers for each pet, and to transmit an instruction signal and collar module address representative of the selected bark training setting and the on/off indicator for each of the at least one stimulus transducers to each collar module, the circuit of each collar module adapted to store the bark training setting and associated on/off indicator for each of the at least one stimulus transducers in the memory, and wherein the circuit of each collar module further includes a bark sensor, whereby when the bark sensor detects that the pet is barking, the selected stimulus transducers are activated based on the bark training settings of that collar module.

18. The training system of claim 17 wherein the bark training setting includes on and off states, whereby when in the off state the circuit of each collar module does not activate the at least one stimulus transducer even when the bark sensor detects the pet is barking.

19. The training system of claim 17 wherein the bark training setting includes on and off states and a grace time indication, and wherein the circuit of each collar module further includes a timer, whereby when a positive grace time is set for each pet on the portable electronic device by the user, the circuit of the collar module associated with the pet activates the at least one stimulus transducers only after the bark sensor detects the designated pet is barking for a longer duration than the grace time.

20. The training system of claim 15 wherein the circuit of each collar module is adapted to assign a distance from the portable electronic device based on a strength measurement of the instruction signal from the portable electronic device, and wherein at least one distance threshold may be programmed in the memory of the circuit and associated with one of the at least one stimulus transducers, in response to the instruction signal received from the portable electronic device, whereby if the distance from the portable electronic device exceeds one of the distance thresholds the associated stimulus transducer is activated.
